(19) United States
(12) Patent Application Publication
(10) Pub. No.: US 2006/0072730 A1
(43) Pub. Date: Apr. 6, 2006

(54) Systems and methods of changing attributes of voice calls over a circuit-based network

(75) Inventor: Dinesh K. Jindal, Naperville, IL (US)

Correspondence Address: DUFT BORNSEN & FISHMAN, LLP, 1526 SPRUCE STREET, SUITE 302, BOULDER, CO, 80302, US

(73) Assignee: Lucent Technologies Inc., Murray Hill, NJ (US)

(21) Appl. No.: 10/953,127

(22) Filed: Sep. 29, 2004

(51) Int. Cl. H04M 3/42

(52) U.S. Cl. 379/207.02

(57) ABSTRACT

Systems and methods are disclosed for changing attributes of voice calls. During a voice call over a connection of a circuit-based network between a first station and a second station through a switching system, the switching system receives audio from the first station. The switching system also detects a code entered by the user of the first station. Upon detecting the code, the switching system changes one or more attributes of the audio received from the first station to generate audio with changed attributes. For instance, the switching system may raise or lower a volume of the audio, may raise or lower the frequency of the audio, may add or remove background tones, or change other attributes. The switching system then transmits the audio with the changed attributes to the second station.

### BACKGROUND OF THE INVENTION

1. Field of the Invention

The invention is related to the field of voice communications, and in particular, to systems and methods of changing attributes of voice calls over a circuit-based network. More particularly, a calling party may instruct the circuit-based network to change the attributes of voice calls.

2. Statement of the Problem

In data communications such as email, a sender of an email can change the attributes of the email that are available in the email application being used by the sender. For instance, the sender of an email can bold, italicize, and/or underline certain words or portions of an email. The sender can also change the font and/or color of certain words or portions of an email. Changing attributes in emails in this manner allows the sender to accentuate or emphasize certain portions of the email, to set off certain portions of the email, or just stylize the email. Also, changing attributes in emails provides new standardized dimensions of communication.

In voice communication services over a circuit-based network, the attributes of a voice call depend on the sounds picked up by a microphone in a telephone and transmitted over the connection for the voice call. The sounds typically include the voice of a party speaking into the telephone and any background noise. If the party speaking into the telephone wants to change the volume or frequency of the voice call, such as to emphasize a word or phrase, the speaking party needs to physically speak louder or change the tone of their voice. If the party speaking into the telephone wants to change the background noise, the party needs to move to another room or otherwise avoid the background noise. One problem with current circuit-based networks is that voice callers using the network do not have the assistance of the network to change the attributes of a voice call. The attributes of a voice call are currently independent of the network, and the voice caller cannot instruct the network to change the attributes of the voice call in a consistent and standardized manner.

### SUMMARY OF THE SOLUTION

The invention solves the above and other related problems with systems and methods that provide for changing attributes of voice calls over a circuit-based network. Changing attributes according to the invention includes changing the attributes of the audio or a portion of the audio of a voice call. A user of a station (e.g., a traditional telephone) connected to the circuit-based network can instruct the circuit-based network to change the attributes of the audio of the voice call, such as volume, frequency, or background noise. Based on the instructions from the user of the station, the circuit-based network changes the attributes of the audio.

One embodiment of the invention is a communication system that includes a circuit-based network comprising a plurality of switching systems. The circuit-based network also includes a connection between a first station and a second station. The switching system enables the connection in order to connect a voice call between the first station and the second station. During the voice call, a user of the first station speaks into the first station. The first station captures the sound of the user's voice, and possibly other sounds in the background, and transmits the audio over the connection to the switching system. At some time during live conversation, the user also enters a code into the first station. The first station transmits the code to the switching system.

The switching system receives the audio from the first station. The switching system also detects the code transmitted over the connection of the voice call. Upon detecting the code, the switching system changes one or more attributes of the audio received by the switching system from the first station to generate audio with changed attributes. For instance, the switching system may raise or lower a volume of the audio, may raise or lower the frequency of the audio, may add or remove background tones, or change other attributes. The switching system then transmits the audio with the changed attributes to the second station.

The communication system described above advantageously allows a user of the first station to change the attributes of the voice call in real-time. Through the code entered into the first station, the user can instruct the switching system to change the attributes of the voice call. The user does not have to change the attributes by changing his/her voice as before, but can instruct the switching system of the network to change the attributes for the user instead.

The invention may include other exemplary embodiments described below.

### DESCRIPTION OF THE DRAWINGS

The same reference number represents the same element on all drawings.

FIG. 1 illustrates a communication system in an exemplary embodiment of the invention.

FIG. 2 is a flow chart illustrating one example operation of the switching system of FIG. 1 in an exemplary embodiment of the invention.

FIG. 3 illustrates another embodiment of the communication system.

### DETAILED DESCRIPTION OF THE INVENTION

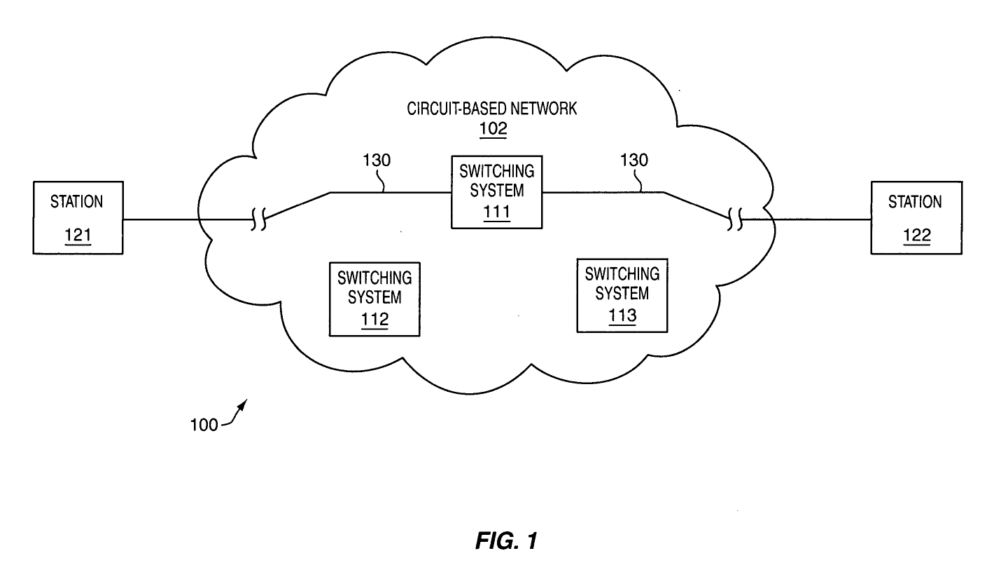

FIGS. 1-3 and the following description depict specific exemplary embodiments of the invention to teach those skilled in the art how to make and use the best mode of the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a communication system 100 in an exemplary embodiment of the invention. Communication system 100 includes a circuit-based network 102 comprising a plurality of switching systems 111-113. Circuit-based network 102 also includes a connection 130 between station 121 and station 122. Switching system 111 enables connection 130 to connect a voice call between station 121 and station 122. There may be other devices or systems on connection 130 between station 121, switching system 111, and station 122 that are not shown for the sake of brevity. Communication system 100 and circuit-based network 102 may include other devices or systems not shown in FIG. 1.

A circuit-based network comprises any network that switches voice calls over circuits, such as a traditional telecommunications network. A switching system comprises any device or system that switches voice calls in a circuit-based network, such as a traditional telecommunications switch. A station comprises any device capable of placing or receiving a voice call over a circuit-based network, such as a traditional telephone.

In FIG. 1, a voice call is connected between station 121 and station 122. During the voice call, a user (not shown) of station 121 speaks into station 121. Station 121 captures the sound of the user's voice, and possibly other sounds in the background, and transmits audio over connection 130 to switching system 111.

At some time during the live conversation the user, the user also enters a code into station 121. The particular code entered by the user is an instruction to change one or more attributes of the audio of the voice call. The user may enter the code via a touch-tone keypad on station 121 in the form of Dual-Tone Multi-Frequency (DTMF) tones. Station 121 transmits the code over connection 130.

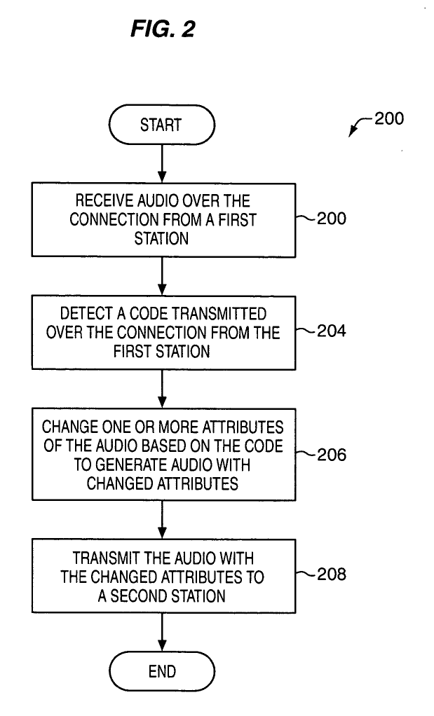

FIG. 2 is a flow chart illustrating one example operation of switching system 111 in an exemplary embodiment of the invention. In step 202, switching system 111 receives the audio transmitted by station 121 over connection 130. In step 204, switching system 111 detects the code transmitted over connection 130 by station 121. For instance, switching system 111 may be configured to detect DTMF tones on connection 130 during an active voice call. Switching system 111 is preferably the originating switch for station 121, but may also be a terminating switch or another switch in between. Responsive to detecting the code, switching system 111 changes one or more attributes of the audio received by switching system 111 from station 121 to generate audio with changed attributes in step 206. For instance, switching system 111 may raise or lower a volume of the audio, may raise or lower the frequency of the audio, may add or cancel background tones, or change other attributes. Switching system 111 then transmits the audio with the changed attributes to station 122 in step 208.

Communication system 100 advantageously allows a user of station 121 to change the attributes of the voice call in real-time. Through the code entered into station 121, the user can instruct switching system 111 to change the attributes of the voice call. The user does not have to change the attributes by changing his/her voice as before, and can instruct switching system 111 to change the attributes for the user.

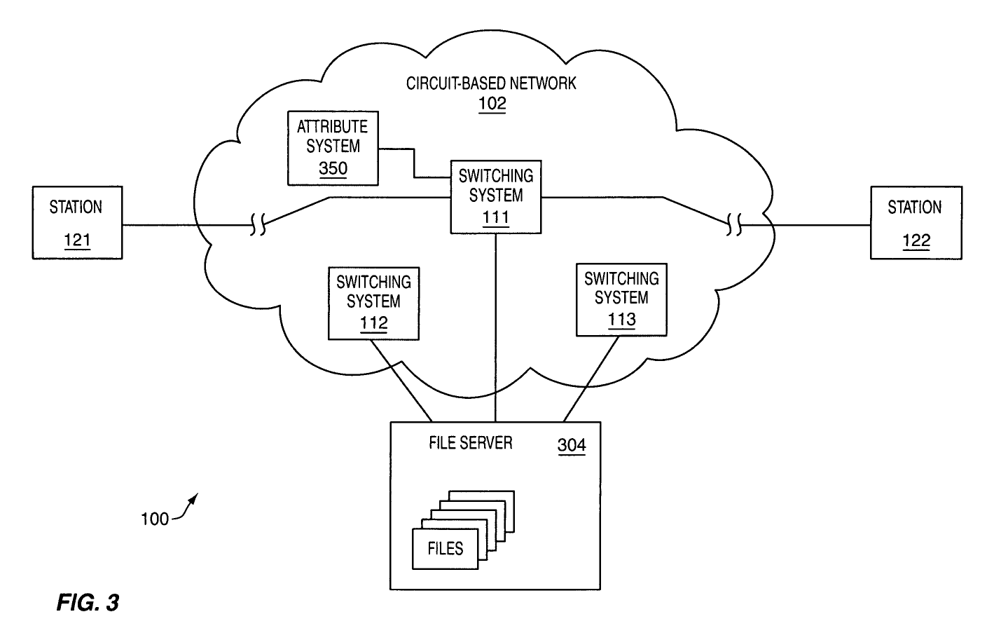

FIG. 3 illustrates another embodiment of communication system 100. In this embodiment, each switching system 111-113 is connected to a file server 304. File server 304 stores a plurality of files for user-defined background tones or standard background tones. A file server comprises any device, system, or server that stores files. One example of a file server in this embodiment is a Service Control Point (SCP) of a telecommunications network. Another example of a file server is a content server on the Internet or a content server on a public or private intranet.

Based on the code provided by the user of station 121, switching system 111 queries file server 304 for the file containing the desired background tones. File server 304 then responds to switching system 111 with the proper file. Switching system 111 then adds the background tones to the voice call.

FIG. 3 also illustrates switching system 111 as being connected to attribute system 350. In the above embodiments, switching system 111 includes the functionality to change the attributes as instructed by the user, such as amplifiers, attenuators, frequency modulators, etc. Switching system 111 may also use attribute system 350 to change one or more of the attributes of the voice call. Attribute system 350 comprises any device or system that changes an attribute of a voice call responsive to instructions from switching system 111. For instance, attribute system 350 may include the functionality to change the attributes of the voice call, such as amplifiers, attenuators, frequency modulators, etc. When switching system 111 detects a code from the user, switching system 111 may then access attribute system 350 to change the desired attribute for switching system 111.

The code used in the above embodiment may have any desired format. One exemplary format of the code is as follows:

[start ID] [attribute ID] . . . [end ID]

The start ID indicates the beginning of the code. The start ID is also a trigger for switching system 111 to change one or more attributes of the voice call. The attribute ID indicates to switching system 111 which attribute to change. There may be multiple attribute IDs to support changing multiple attributes. The attribute ID may also indicate how to change the attribute. For instance, if the attribute ID instructs switching system 111 to raise or lower the volume of the audio, the attribute ID may also indicate the level to raise or lower the volume. If the attribute ID instructs switching system 111 to raise or lower the frequency of the audio, the attribute ID may also indicate the level to raise or lower the frequency. If the attribute ID instructs switching system 111 to add background tones to the audio, the attribute ID may also instruct which background tones to add to the audio. Switching system 111 may include a database of background tones that the user may access. For instance, if a person is home alone and places a call, that person may instruct switching system 111 to add background tones that sounds like other people are home. These overtones can be pre-defined standard tones identified by their unique tone IDs or user defined. In case of user-defined tones, the tone ID will indicate that it is user defined followed by the location of the user-defined tone at a private or public domain. There may be multiple attribute IDs to support changing multiple attributes. The end ID indicates the end of the code. The IDs may be numbers, letters, or special characters.

The following example illustrates an actual code that may be used. In this example, a service provider creates a code that is provided to the user of station 121. The code instructs switching system 111 how to change attributes of a voice call. In this example, the service provider labels the start ID as “*0” and the end ID as “*9”. The service provider labels the attribute ID for raising the volume of the audio of the voice call as “01”. The service provider labels the attribute ID for lower the volume of the audio as “02”. The service provider labels the attribute ID for raising the frequency of the audio as “03”. The service provider labels the attribute ID for lowering the frequency of the audio as “04”. The service provider labels the attribute ID for adding a background tone to the audio as “05”. The tone ID “00” indicates that the tone is user-defined. The characters “*#” indicates end of user-defined tone ID location.

Assume during a voice call that the user speaks into station 121 “If you don't pay the dues in time, we will disconnect your services.” Also assume that before the user speaks “dues in time”, the user enters “*0 01 02” via the touch-tone keypad on station 121, followed by “*9”. The characters “*0” indicate the start of the code. The characters “01” indicates that the volume of “dues in time” is to be raised. The characters “02” indicates that the volume is to be raised by two levels. The characters “*9” after “dues in time” indicates the end of the code. Based on this code, switching system 111 would raise the volume of the words “dues in time” by two levels for the user.

Assume again that during a voice call, the user enters “*0 05 50 *9” via the touch-tone keypad on station 121. The characters “*0” indicate the start of the code. The characters “05” indicates that background tones are to be added to voice call. The characters “50” indicates which background tones are to be added. Switching system 111 may look up the proper background tones in file server 304 using the code “50”. The characters “*9” indicates the end of the code. Based on this code, switching system 111 would add a pre-defined background tone to the voice call.

Assume again that during a voice call, the user enters “*0 05 00 www.myaudios.com/audio01.mp3*# *9” via the touch-tone keypad on station 121. The characters “*0” indicate the start of the code. The characters “05” indicates that background tones are to be added to voice call. The characters “00” indicates that the background tone to be added is user-defined at location www.myaudios.com/audio01.mp3. Switching system 111 may look up the proper background tones from the public/private domain. The characters “*9” indicates the end of the code. Based on this code, switching system 111 would add a user-defined background tone to the voice call.

The service provider designates how the code is entered via a touch-tone keypad. One way to enter letters, numbers, and special characters over the keypad is to enter two digits for each letter, number, or special character. For numbers, the first digit is a zero followed by the digit. For instance, “00” represents a zero, “01” represents a one, “02” represents a two, etc. Most keypads have letters on the digits. The letters are entered as the digit followed by a “1”, “2”, “3”, or “4” depending on whether it's the first, second, third, or fourth letter on that digit. For instance, “21” represents an A, “22” represents a B, “23” represents a C, “31” represents a D, “32” represents an E, “33” represents an F, etc. For special characters, any other two-digit code is used that is not already being used for number or letters. For instance, “11” represents the “@” character, “12” represents the “:” character, “13” represents the “\” character, etc.

I claim:

1. A communication system for changing attributes of voice calls, the communication system comprising:
a switching system of a circuit-based network; and
a connection that connects a voice call between a first station and a second station over the circuit-based network through the switching system;
the switching system receives audio having first attributes for the voice call from the first station, detects a code from the first station during the voice call, changes at least one of the first attributes of the audio based on the code to generate audio having second attributes, and transmits the audio having the second attributes to the second station.

2. The communication system of claim 1 wherein:
the switching system raises or lowers the volume of the audio based on the code.

3. The communication system of claim 3 wherein the code indicates a level of raising or lowering the volume.

4. The communication system of claim 1 wherein:
the switching system raises or lowers the frequency of the audio based on the code.

5. The communication system of claim 4 wherein the code indicates a level of raising or lowering the frequency.

6. The communication system of claim 1 wherein:
the switching system adds background tones to the audio based on the code.

7. The communication system of claim 6 wherein:
the code indicates a background tone to add to the audio.

8. The communication system of claim 1 wherein:
the switching system cancels background tones from the audio based on the code.

9. The communication system of claim 1 wherein the code includes a start identifier, an attribute identifier, and an end identifier.

10. The communication system of claim 1 wherein:
the switching system detects the code by detecting Dual-Tone Multi-Frequency (DTMF) tones.

11. A method of changing attributes of voice calls in a communication system, the communication system comprising a switching system of a circuit-based network and a connection that connects a voice call between a first station and a second station over the circuit-based network through the switching system, the method comprising the steps of:
receiving audio having first attributes for the voice call in the switching system from the first station;
detecting a code from the first station during the voice call in the switching system;
changing at least one of the first attributes of the audio based on the code in the switching system to generate audio having second attributes; and
transmitting the audio having the second attributes from the switching system to the second station.

12. The method of claim 11 wherein the step of changing at least one of the first attributes of the audio based on the code comprises the step of:
raising or lowering the volume of the audio based on the code.

13. The method of claim 12 wherein the code indicates a level of raising or lowering the volume.

14. The method of claim 11 wherein the step of changing at least one of the first attributes of the audio based on the code comprises the step of:
raising or lowering the frequency of the audio based on the code.

15. The method of claim 14 wherein the code indicates a level of raising or lowering the frequency.

16. The method of claim 11 wherein the step of changing at least one of the first attributes of the audio based on the code comprises the step of:
adding background tones to the audio based on the code.

17. The method of claim 16 wherein the code indicates a background tone to add to the audio.

18. The method of claim 11 wherein the step of changing at least one of the first attributes of the audio based on the code comprises the step of:
canceling background tones from the audio based on the code.

19. The method of claim 11 wherein the code includes a start identifier, an attribute identifier, and an end identifier.

20. The method of claim 11 wherein the step of detecting a code from the first station comprises the step of:
detecting Dual-Tone Multi-Frequency (DTMF) tones.
